(19) United States
(12) Patent Application Publication
(10) Pub. No.: US 2018/0005776 A1
(43) Pub. Date: Jan. 4, 2018

(54) TERMINAL CONNECTING MECHANISM AND SWITCH

(71) Applicant: OMRON Corporation, Kyoto-shi (JP)

(72) Inventors: Hiroyuki OTSUKA, Izumo-shi (JP); Kazuaki MORITA, Okayama-shi (JP); Shinya KATSUBE, Okayama-shi (JP)

(73) Assignee: OMRON Corporation, Kyoto-shi (JP)

(21) Appl. No.: 15/602,238

(22) Filed: May 23, 2017

(30) Foreign Application Priority Data
Jun. 29, 2016 (JP) 2016-129239

(51) Int. Cl. H01H 13/04; H01H 13/14; H01R 9/24

(52) U.S. Cl. CPC H01H 13/04; H01R 9/2416; H01H 13/14; H01H 2235/01

(57) ABSTRACT

A terminal connecting mechanism includes a plate spring, an insulating housing having an accommodating portion to accommodate a fixed portion and an elastic portion of the plate spring, and a terminal electrode portion disposed in the accommodating portion. The accommodating portion includes a first opening to allow a conductor portion of an electric wire to be inserted into the accommodating portion, an electric wire insertion guide wall disposed from the first opening along an insertion direction of the electric wire, to guide the conductor portion, an inclined wall facing the electric wire insertion guide wall and being inclined toward the electric wire insertion guide wall along the insertion direction of the electric wire, wherein the fixed portion is fixed to the inclined wall, and a second opening to allow a jig to be inserted into the accommodating portion, thereby canceling contact between the elastic portion and the conductor portion.

### CROSS-REFERENCES TO RELATED APPLICATIONS

This application claims priority to Japanese Patent Application No. 2016-129239 filed Jun. 29, 2016, the entire contents of which are incorporated herein by reference.

### FIELD

The present disclosure relates to a terminal connecting mechanism and a switch including the same.

### BACKGROUND

Examples of switches having a plunger configured to move back and forth between a returned position at which a movable contact is located away from a fixed contact and an operating position at which the movable contact is in contact with the fixed contact include a commercially available switch 301 shown in FIG. 13. The switch 301 includes a terminal connecting mechanism 330. The terminal connecting mechanism 330 includes a housing 350 having a first opening 352 configured to allow a conductor portion of an electric wire to be inserted thereinto and a second opening 355 configured to allow a jig to be inserted thereinto, a plate spring 340 accommodated in the housing 350, and a terminal electrode portion 360 configured to allow the conductor portion of the electric wire to be in contact therewith. The terminal connecting mechanism 330 is configured such that the conductor portion of the electric wire inserted into the housing 350 via the first opening 352 is held between the plate spring 340 and the terminal electrode portion 360, and the contact between the plate spring 340 and the conductor portion of the electric wire is canceled by a jig inserted into the housing 350 via the second opening 355.

### SUMMARY

However, in the above-described switch 301, the plate spring 340 does not have a simple U-shape, but has a complex shape with a plurality of curved portions, and thus the size of the housing 350 is large. Accordingly, there are cases in which the terminal connecting mechanism 330 and the switch 301 including this terminal connecting mechanism 330 cannot be made smaller.

It is an object of an embodiment of the present invention to provide a smaller terminal connecting mechanism and a smaller switch.

An aspect of the present invention may be directed to a terminal connecting mechanism including;
a plate spring having a fixed portion at one end thereof, an elastic portion at another end configured to be elastically deformable relative to the fixed portion, and a curved portion linking the fixed portion and the elastic portion;
an insulating housing having an accommodating portion including a jig insertion region that allows a jig to be inserted thereinto and an electric wire insertion region that allows a conductor portion of an electric wire to be inserted thereinto, configured to accommodate the fixed portion and the elastic portion of the plate spring, and further including an elastic deformation region in which the elastic portion is allowed to elastically deform passing through the electric wire insertion region toward the fixed portion, to the jig insertion region; and
a terminal electrode portion disposed in the accommodating portion, and configured to allow the conductor portion of the electric wire inserted into the electric wire insertion region to be in contact therewith,
wherein the accommodating portion includes;
   a first opening disposed on the electric wire insertion side of the accommodating portion, and configured to allow the conductor portion of the electric wire to be inserted into the electric wire insertion region in the accommodating portion;
   an electric wire insertion guide wall disposed from the first opening along an insertion direction of the electric wire so as to support the terminal electrode portion, and configured to guide the conductor portion of the electric wire inserted from the first opening, and to hold the conductor portion between the elastic portion of the plate spring and the terminal electrode portion;
   an inclined wall disposed so as to face the electric wire insertion guide wall and to be inclined toward the electric wire insertion guide wall along the insertion direction of the electric wire, wherein the fixed portion of the plate spring is fixed to the inclined wall; and
   a second opening disposed adjacent to the first opening, on the electric wire insertion side of the accommodating portion, and configured to allow the jig to be inserted into the accommodating portion to be brought into contact with the elastic portion of the plate spring, thereby canceling contact between the elastic portion and the conductor portion of the electric wire.

Furthermore, another aspect of the present invention may be directed to a switch, including:
a fixed contact;
a movable contact configured to be in contact with and away from the fixed contact; and
the terminal connecting mechanism in which the terminal electrode portion is electrically connected to the fixed contact or the movable contact.

According to the terminal connecting mechanism of the present invention, the accommodating portion includes an electric wire insertion guide wall disposed along an insertion direction of the electric wire and configured to guide the conductor portion of the electric wire, and an inclined wall disposed so as to face the electric wire insertion guide wall and to be inclined toward the electric wire insertion guide wall so as to reduce the space in the accommodating portion, instead of being parallel to the electric wire insertion guide wall, wherein the fixed portion of the plate spring is fixed to the inclined wall. Accordingly, the size of the housing is reduced, and thus the terminal connecting mechanism is smaller.

According to the above aspects, the switch becomes smaller due to the terminal connecting mechanism being smaller.

### BRIEF DESCRIPTION OF THE DRAWINGS

FIG. 1 is a perspective view of a switch including terminal connecting mechanisms according to an embodiment of the present invention.

FIG. 2 is a perspective view of the switch in FIG. 1 viewed in a direction different from that in FIG. 1.

FIG. 3 is a front view of a returned state of the switch in FIG. 1 without a cover.

FIG. 4 is a front view of an operating state of the switch in FIG. 1 without a cover.

FIG. 5 is an enlarged front view showing a terminal connecting mechanism of the switch in FIG. 1.

FIG. 6 is a front view showing a state in which an electric wire and a jig are inserted into the terminal connecting mechanism of the switch in FIG. 1.

FIG. 7 is a cross-sectional view showing a state in which the electric wire is inserted into the terminal connecting mechanism of the switch in FIG. 1.

FIG. 8 is a cross-sectional view showing a state in which the electric wire and the jig are inserted into the terminal connecting mechanism of the switch in FIG. 1.

FIG. 9 is a perspective view illustrating another example of the switch in FIG. 1.

FIG. 10 is a front view showing a returned state of the switch in FIG. 9 without a cover.

FIG. 11 is a perspective view of an LED lamp lightning unit, which is another example of the switch in FIG. 1.

FIG. 12 is a front view of the LED lamp lightning unit in FIG. 11 without a cover.

FIG. 13 is a view illustrating a commercially available switch.

### DETAILED DESCRIPTION

Hereinafter, embodiments of the present invention will be described with reference to the accompanying drawings. Note that in the description below, terms indicating specific positions and directions (e.g., terms including “upper”, “lower”, “right”, and “left”) are used as necessary in order to facilitate understanding of the invention as indicated in the drawings and are not intended to limit the technical scope of the invention according to their respective meanings. Also, the description below is merely an example and is not intended to limit the present invention, its application, or its use. The drawings are schematic, and ratios and the like of dimensions therein do not necessarily match those in the actual state.

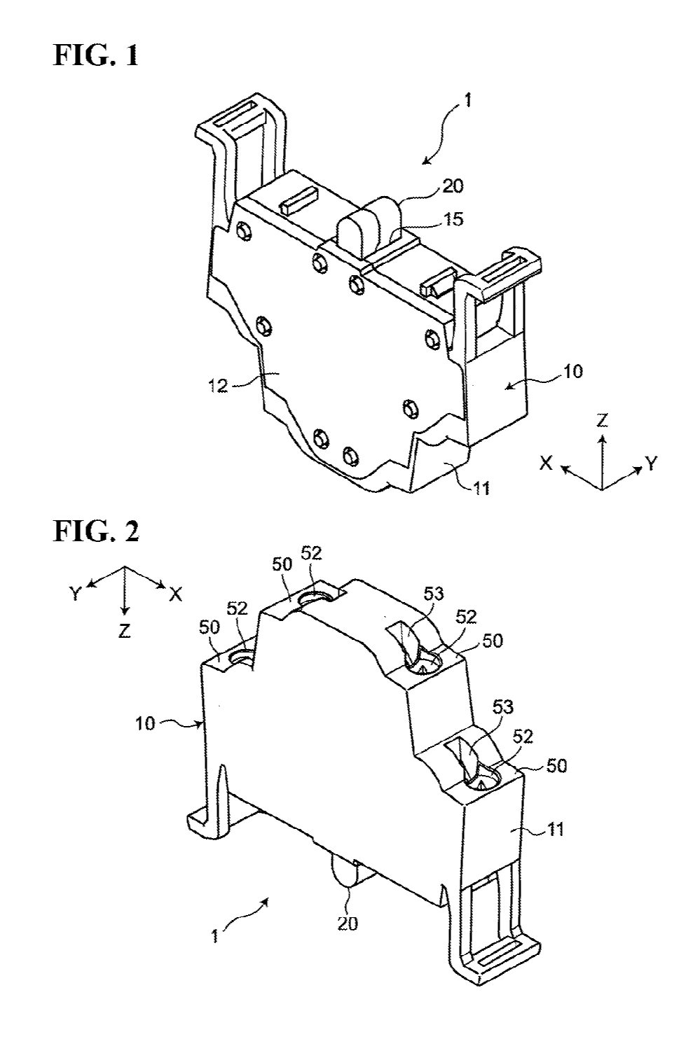

A switch 1 including terminal connecting mechanisms according to an embodiment includes an insulating main body 10 and an insulating plunger 20 as shown in FIGS. 1 and 2. The plunger 20 is accommodated in the main body 10 in a state where the plunger 20 partially protrudes to the outside of the main body 10.

In FIG. 1, the width direction of the main body 10 is taken as an X direction, the thickness direction of the main body orthogonal to the X direction is taken as a Y direction, and the height direction of the main body orthogonal to the X and Y directions is taken as a Z direction.

As shown in FIG. 1, the main body 10 is configured by a casing 11 that has an opening on one of the faces thereof in the Y direction, and a cover 12 that covers the opening. The face on the upper side in the Z direction of the casing 11 is provided with a groove 15 through which the plunger 20 can partially protrude.

As shown in FIGS. 1 and 2, the casing 11 is symmetric about the X-directional center line extending in the Z direction in a plan view in the Y direction, and is symmetric about the Y-directional center line extending in the Z direction in a plan view in the X direction.

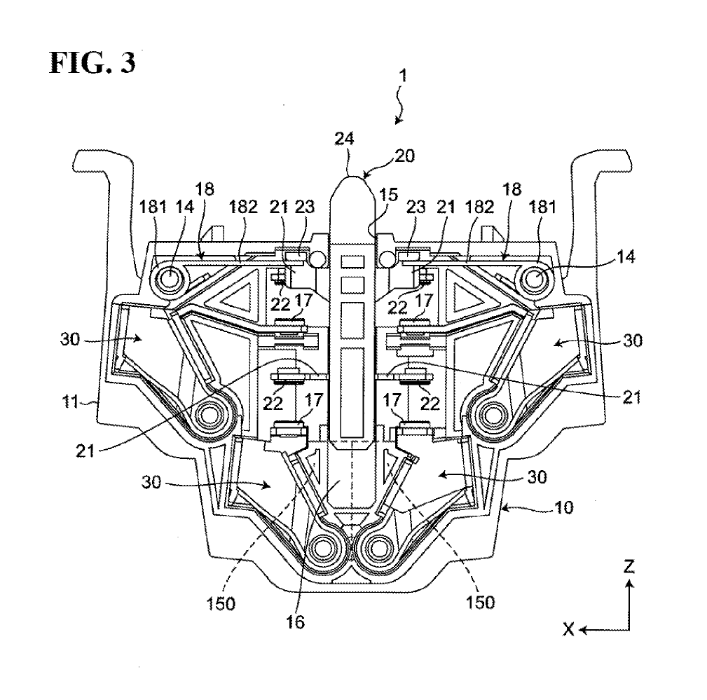

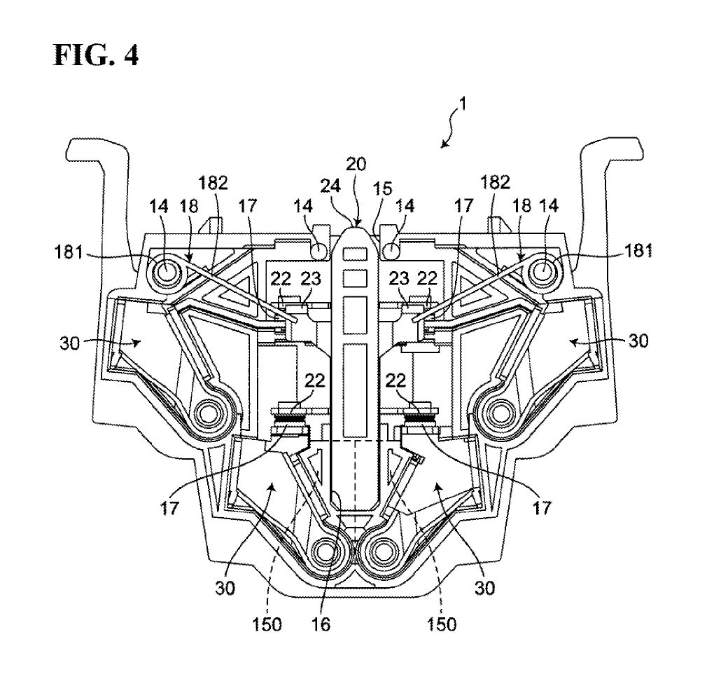

As shown in FIGS. 3 and 4, a passage 16 disposed at the center in the X direction and extending along the Z direction is provided inside the casing 11. The passage 16 extends to the outside of the casing 11 via the groove 15 on the face on the upper side in the Z direction of the casing 11, and the plunger 20 can be accommodated in the passage 16.

Furthermore, four fixed contacts 17 arranged so as to be divided into two upper and lower levels in the direction (the Z direction) in which the passage 16 extends, and four terminal connecting mechanisms 30 electrically connected respectively to the fixed contacts 17 are provided inside the casing 11. The four terminal connecting mechanisms 30 are also arranged so as to be divided into two upper and lower levels in the direction in which the passage 16 extends.

Moreover, two torsion springs 18 arranged on the upper side in the Z direction of the terminal connecting mechanisms 30 in the upper level are provided inside the casing 11. Each of the torsion springs 18 is configured by a coil portion 181 fitted to a protrusion 14 in the shape of a solid cylinder disposed at both ends of the upper portion in the Z direction of the casing 11, and an arm portion 182 extending from the coil portion 181 along the face on the upper side in the Z direction of the casing 11 toward the groove 15. The torsion springs 18 are arranged such that an elastic force acts toward the upper side in the Z direction in the state shown in FIG. 3.

The cover 12 is in the shape of a plate that can cover the opening of the casing 11.

As shown in FIGS. 3 and 4, the plunger 20 is a rod-like member extending in the shape of a straight line, and has a curved end face 24 on one of the sides thereof in the lengthwise direction (the Z direction). The plunger 20 is provided with four contact arm portions 21 that protrude in the widthwise direction (the X direction) from both side faces thereof extending in the lengthwise direction (the Z direction).

The four contact arm portions 21 have ends respectively provided with movable contacts 22, and are arranged so as to be symmetric about the lengthwise direction of the plunger 20 and to be divided into two upper and lower levels in the lengthwise direction. The contact arm portions 21 in the upper level are respectively provided with elastic force receiving portions 23 that are in contact with the arm portions 182 of the torsion springs 18 and receive an elastic force therefrom. The four contact arm portions 21 are arranged such that the gap between the contact arm portions 21 in the upper level and the contact arm portions 21 in the lower level substantially conforms to the gap between the fixed contacts 17 in the upper level and the fixed contacts 17 in the lower level of the casing 11.

In a returned state in which no external force is applied to the plunger 20, as shown in FIG. 3, the plunger 20 is pressed against the face on the upper side in the Z direction of the casing 11 by an elastic force generated by the two torsion springs 18 received via the elastic force receiving portions 23 of the contact arm portions 21 in the upper level, and the end face 24 of the plunger 20 protrudes from the groove 15 to the outside of the casing 11. In the returned state, each movable contact 22 faces its corresponding fixed contact 17 of the casing 11, and is located away from that facing fixed contact 17.

At an operating position at which a downward force in the Z direction is applied to the end face 24 of the plunger 20 so that the plunger 20 is pressed into the casing 11, as shown in FIG. 4, the end face 24 of the plunger 20 is pressed from the groove 15 into the casing 11, and each movable contact 22 of the plunger 20 comes into contact with its facing fixed contact 17 of the casing 11. At this time, if the force applied to the end face 24 of the plunger 20 is canceled, the plunger 20 is biased toward the upper side in the Z direction by the elastic force generated by the torsion springs 18, and returns to the returned position shown in FIG. 3.

That is to say, the plunger 20 is configured to move back and forth between a returned position at which the movable contacts 22 are located away from their facing fixed contacts 17 shown in FIG. 3 and an operating position at which the movable contacts 22 are contact with their facing fixed contacts 17 shown in FIG. 4.

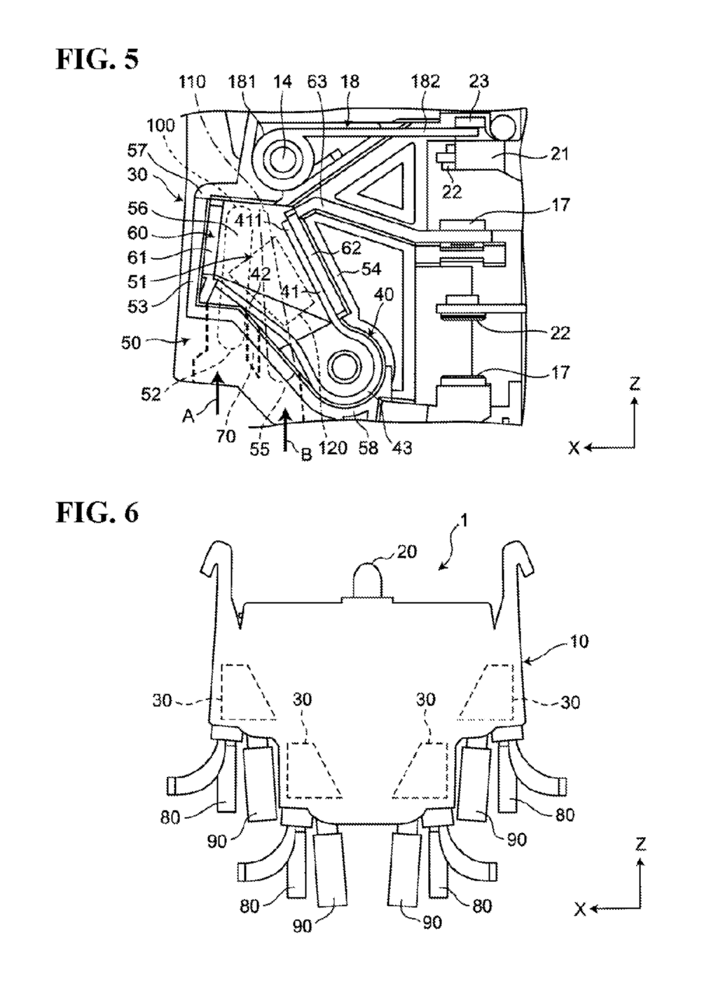

As shown in FIG. 5, each of the terminal connecting mechanisms 30 includes a plate spring 40, a housing 50, and a terminal electrode portion 60. Note that FIG. 5 shows the terminal connecting mechanism 30 positioned in the upper level on the left side in the X direction, from among the four terminal connecting mechanisms 30.

As shown in FIG. 5, the plate spring 40 includes a fixed portion 41 at one of the ends thereof, an elastic portion 42 at the other end configured to be elastically deformable relative to the fixed portion 41, and a curved portion 43 linking the fixed portion 41 and the elastic portion 42.

The fixed portion 41 extends in the shape of a straight line along a later-described inclined wall 54 of the housing 50. The elastic portion 42 has an end that extends to a later-described electric wire insertion guide wall 53 of the housing 50, and is disposed so as to block a first opening 52 and a second opening 55 of a later-described accommodating portion 51. A slit (not shown) extending in the X direction is formed at the center in the Y direction of the elastic portion 42 and the curved portion 43.

The housing 50 is part of the casing 11, and forms part of the insulating main body 10. As shown in FIG. 5, an accommodating portion 51 substantially in the shape of a trapezoid in a plan view in the Y direction is provided inside the housing 50.

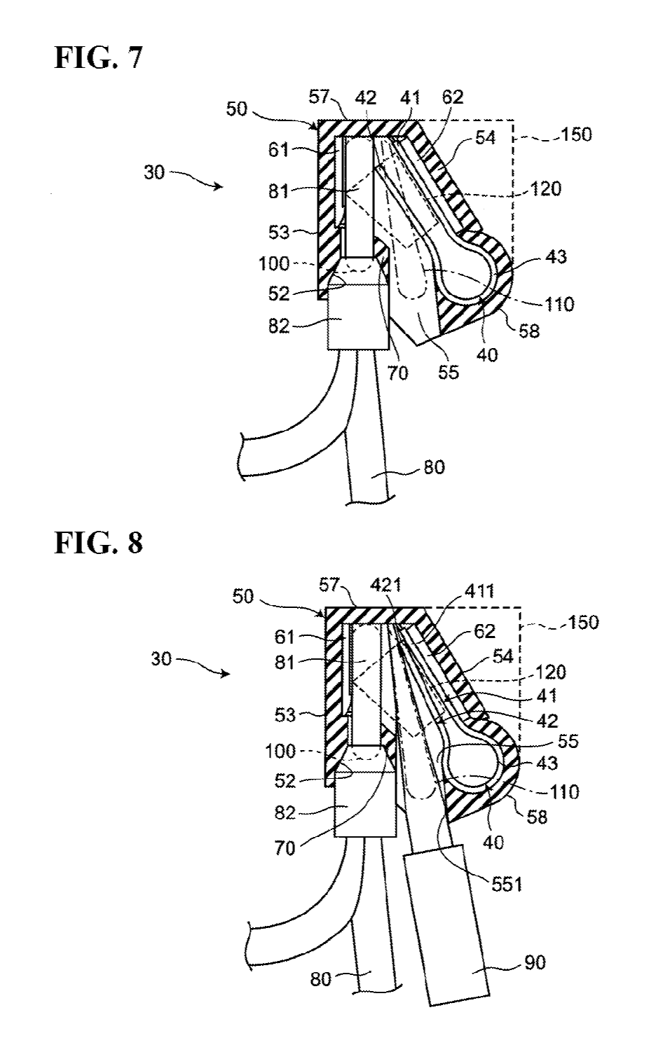

As shown in FIG. 5, the accommodating portion 51 includes an electric wire insertion region 100, a jig insertion region 110, and an elastic deformation region 120. The electric wire insertion region 100 is a region into which a conductor portion 81 of an electric wire 80 (see FIG. 7) may be inserted, and the jig insertion region 110 is a region into which a jig 90 (see FIG. 8) may be inserted. The elastic deformation region 120 is a region in which the elastic portion 42 of the plate spring 40 may elastically deform passing through (traversing) the electric wire insertion region 100 toward the fixed portion 41, to the jig insertion region 110.

Furthermore, the accommodating portion 51 includes the first opening 52, the electric wire insertion guide wall 53, the inclined wall 54, and the second opening 55.

The first opening 52 is disposed at an edge on the electric wire insertion side (the lower side in the Z direction) of the accommodating portion 51. The first opening 52 allows a conductor portion of an electric wire to be inserted into the electric wire insertion region 100 in the accommodating portion 51.

The electric wire insertion guide wall 53 is disposed from the first opening 52 along an insertion direction A of the conductor portion of the electric wire so as to support the terminal electrode portion 60, in the electric wire insertion region 100. The electric wire insertion guide wall 53 guides the conductor portion of the electric wire inserted from the first opening 52, holds the conductor portion of the electric wire between the elastic portion 42 of the plate spring 40 and the terminal electrode portion 60, and electrically connects the conductor portion of the electric wire and the terminal electrode portion 60.

The inclined wall 54 is disposed so as to face the electric wire insertion guide wall 53 and to be inclined toward the electric wire insertion guide wall 53 along the insertion direction A of the electric wire. The fixed portion 41 of the plate spring 40 is fixed to the inclined wall 54 via the terminal electrode portion 60.

The second opening 55 is disposed adjacent to the first opening 52 along the X direction, at an edge on the electric wire insertion side (the lower side in the Z direction) of the accommodating portion 51. The second opening 55 allows a jig to be inserted into the jig insertion region 110 in the accommodating portion 51. If the jig is inserted from the second opening 55 along the insertion direction B into the jig insertion region 110 in the accommodating portion 51, the jig is brought into contact with the elastic portion 42 of the plate spring 40 traversing the jig insertion region 110 and warps it resisting the spring force thereof, thereby canceling the contact between the elastic portion 42 and the conductor portion of the electric wire.

As shown in FIG. 5, the electric wire insertion guide wall 53 and the inclined wall 54 form a pair of legs of the accommodating portion 51 substantially in the shape of a trapezoid, and a bottom wall 57 linking the Z-directional upper end of the electric wire insertion guide wall 53 and the Z-directional upper end of the inclined wall 54 and a wall 58 on the electric wire insertion side facing the bottom wall 57 form a pair of bottom sides of the accommodating portion 51 substantially in the shape of a trapezoid. That is to say, the accommodating portion 51 is configured such that the conductor portion of the electric wire, the end of the jig, the fixed portion 41 of the plate spring 40, and the end of the elastic portion 42 are closely arranged together on the short side on the upper side in the Z direction, of the pair of bottom sides, and the middle portions of the electric wire and the jig and the curved portion 43 of the plate spring 40 are closely arranged together on the long side on the lower side in the Z direction. Accordingly, wasted space is eliminated from the accommodating portion 51 as a whole, and space conservation is achieved.

The terminal electrode portion 60 is configured by an electric wire contact portion 61 in the shape of a plate extending along the electric wire insertion guide wall 53, a plate spring fixing portion 62 in the shape of a plate extending along the inclined wall 54, and a conducting route portion 63 extending along the bottom face (the face on the other side in the Y direction facing the face having the opening) of the casing 11, and connected to the electric wire contact portion 61, the plate spring fixing portion 62, and the fixed contacts 17.

Furthermore, the housing 50 includes a jig support portion 70 that is disposed between the first opening 52 and the second opening 55 of the accommodating portion 51, and is closer to the second opening 55 between the second opening 55 and an end 411 of the fixed portion 41. The jig support portion 70 forms part of the first opening 52 on the inclined wall 54 side, and further forms part of the edge portion of the second opening 55 on the electric wire insertion guide wall 53 side.

Next, an operation of the terminal connecting mechanism 30 when the conductor portion 81 of the electric wire 80 is inserted into the first opening 52 and the jig 90 is inserted into the second opening 55 will be described with reference to FIGS. 6 to 8.

If the conductor portion 81 of the electric wire 80 is inserted from the first opening 52 of the terminal connecting mechanism 30 of the switch 1 into the electric wire insertion region 100 in the accommodating portion 51, the conductor portion 81 inserted into the electric wire insertion region 100 in the accommodating portion 51 is guided along the electric wire insertion guide wall 53 and warps the elastic portion 42 of the plate spring 40 resisting the spring force thereof. Then, the conductor portion 81 of the electric wire 80 is stopped from moving in a state where the first opening 52 is blocked by an insulating collar 82 shown in FIG. 7. At this time, the conductor portion 81 is held between the elastic portion 42 of the plate spring 40 and the electric wire contact portion 61 of the terminal electrode portion 60 due to the spring force of the elastic portion 42, and thus the conductor portion 81 is electrically connected to the electric wire contact portion 61.

Furthermore, if the jig 90 is inserted from the second opening 55, the end of the jig 90 is brought into contact with the elastic portion 42 of the plate spring 40 as shown in FIG. 8 and further warps the elastic portion 42 of the plate spring 40 resisting the spring force thereof. Accordingly, the contact between the elastic portion 42 of the plate spring 40 and the conductor portion 81 of the electric wire 80 is canceled, and thus the conductor portion 81 of the electric wire 80 in the accommodating portion 51 can be pulled out of the accommodating portion 51. At this time, an end 421 of the elastic portion 42 is warped by the jig 90 so as to be in contact with the end 411 of the fixed portion 41. Furthermore, the jig 90 is held between the jig support portion 70 and two points that are an edge portion 551 on the inclined wall 54 side of the second opening 55 and the end 411 of the fixed portion 41 in contact therewith via the end 421 of the elastic portion 42 of the plate spring 40.

In this manner, according to the terminal connecting mechanism 30 of this embodiment, the accommodating portion 51 includes the electric wire insertion guide wall 53 disposed along the electric wire insertion direction and configured to guide the conductor portion 81 of the electric wire 80, and the inclined wall 54 disposed so as to face the electric wire insertion guide wall 53, wherein the fixed portion 41 of the plate spring 40 is fixed to the inclined wall 54. The inclined wall 54 is not parallel to the electric wire insertion guide wall 53, and is inclined (see FIGS. 3 and 4) so as to make a space 150 smaller than that of, for example, a substantially square-shaped accommodating portion in which the fixed portion 41 of the plate spring 40 is fixed to a wall extending parallel to the electric wire insertion guide wall 53. Accordingly, space conservation in the accommodating portion 51 is achieved, the size of the housing 50 is reduced, and the terminal connecting mechanism 30 is smaller.

According to the switch 1 of this embodiment, as shown in FIG. 3, the passage 16 is disposed in the space 150 that has been made smaller than that of a terminal connecting mechanism having a substantially square-shaped accommodating portion. Accordingly, the size of the switch 1 as a whole is made smaller than that of a switch including the terminal connecting mechanism having the substantially square-shaped accommodating portion.

Furthermore, if the jig 90 is inserted from the second opening 55 into the jig insertion region 110 in the accommodating portion 51, the end 411 of the fixed portion 41 of the plate spring 40 and the end 421 of the elastic portion 42 of the plate spring 40 are brought into contact with each other. Accordingly, the elastic portion 42 is restricted from elastically deforming, the elastic portion 42 is prevented from plastically deforming, and thus a restricting portion that restricts elastic deformation of the elastic portion 42 does not have to be additionally provided, and space conservation in the accommodating portion 51 is achieved. Furthermore, the end 411 of the fixed portion 41 of the plate spring 40 restricts elastic deformation of the elastic portion 42, and thus wear resistance is higher than that in the case where the restricting portion is made of a resin or the like.

Furthermore, the housing 50 includes the jig support portion 70 that is disposed between the first opening 52 and the second opening 55, and is closer to the second opening 55 between the second opening 55 and the end 411 of the fixed portion 41 of the plate spring 40. Accordingly, when viewed in a cross-section along the insertion direction A of the conductor portion 81 of the electric wire 80 and along the direction traversing the first opening 52 and the second opening 55, the jig 90 is held between the jig support portion 70 and two points that are the edge portion 551 on the inclined wall 54 side of the second opening 55 and the end 411 of the fixed portion 41 in contact therewith via the end 421 of the elastic portion 42 of the plate spring 40. As a result, the jig 90 can be held in a hands-free state without supporting it with a hand or the like.

Furthermore, the jig support portion 70 is configured to warp when the jig 90 is inserted into the second opening 55. Accordingly, the jig 90 is held more reliably.

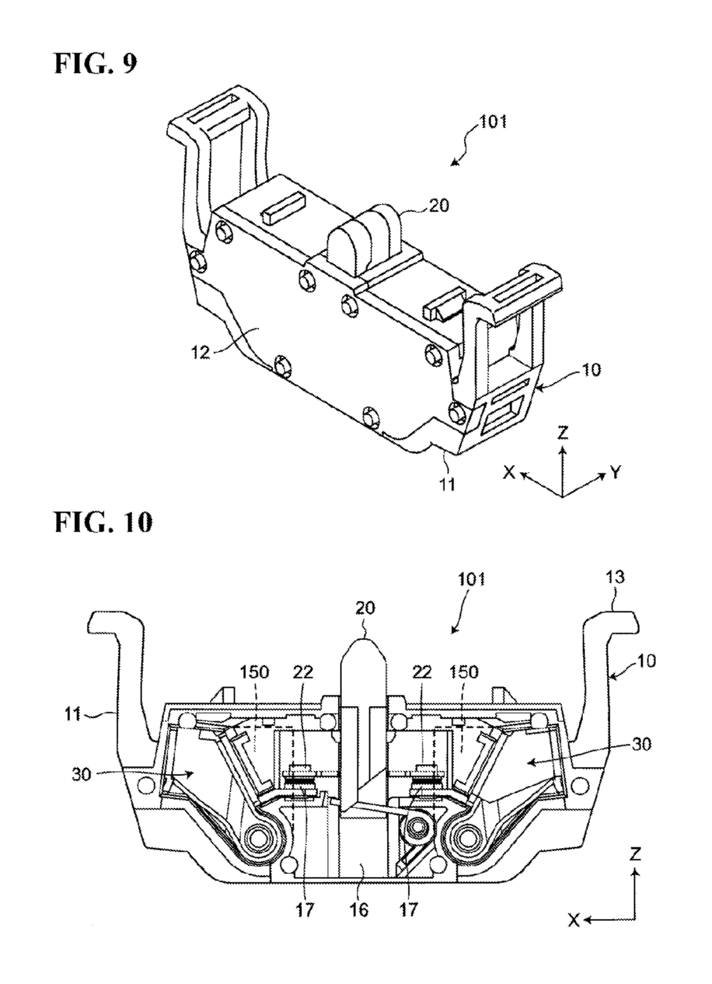

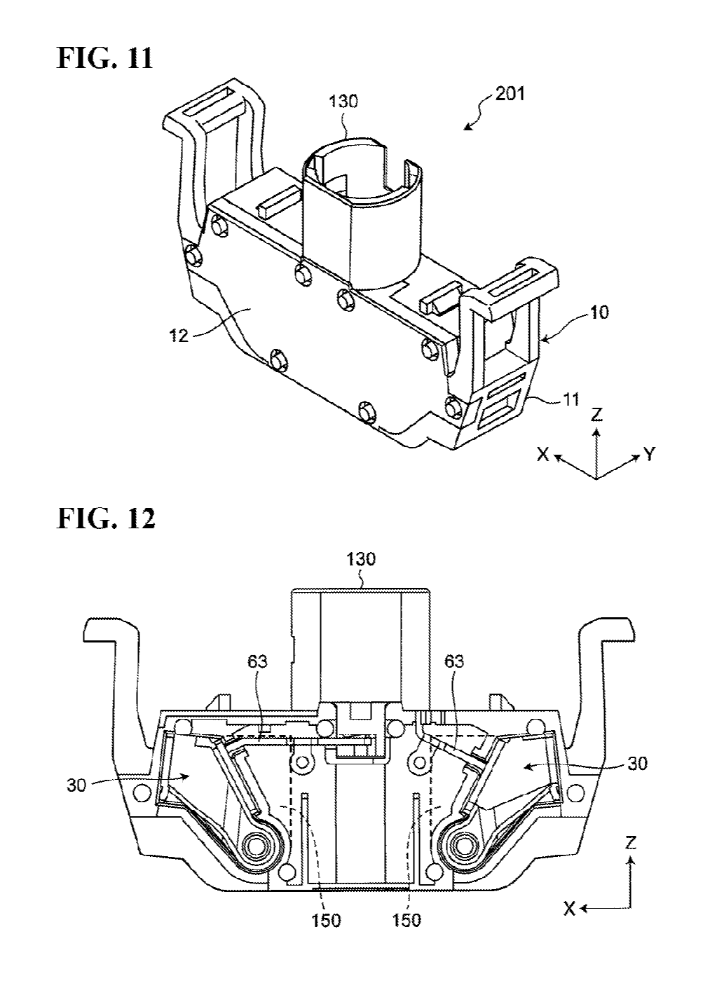

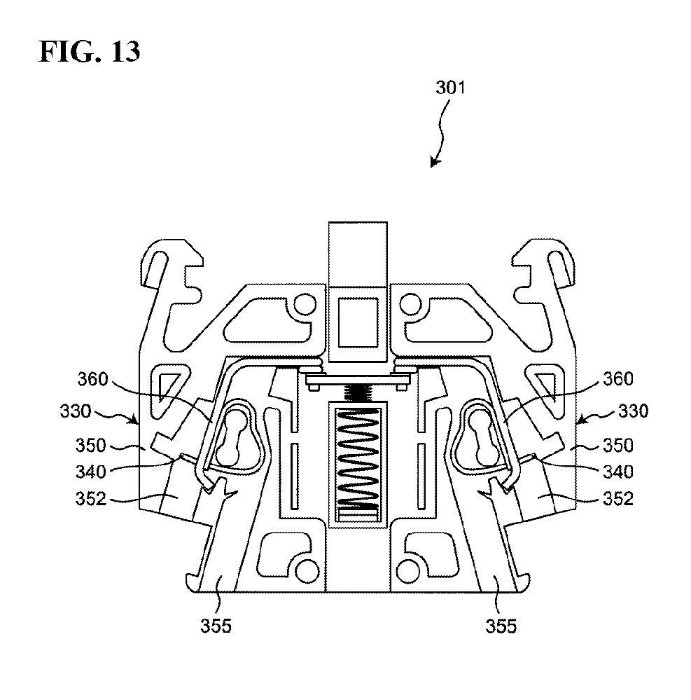

The terminal connecting mechanism 30 is applicable not only to the switch 1 described above, but also to, for example, a switch 101 shown in FIGS. 9 and 10 or an LED lamp lightning unit 201 shown in FIGS. 11 and 12.

In the switch 101 shown in FIGS. 9 and 10, two terminal connecting mechanisms 30 are symmetrically arranged about the passage 16. The fixed contact 17 and the movable contact 22 are arranged in each space 150 that has been made smaller than that of a substantially square-shaped accommodating portion. Accordingly, the size of the switch 101 as a whole is made smaller than that of a switch including the terminal connecting mechanism having the substantially square-shaped accommodating portion.

In the LED lamp lightning unit 201 shown in FIGS. 11 and 12, a socket 130 to which an LED can be attached is provided substantially at the center on the face on the upper side in the Z direction, instead of the plunger 20 and the passage 16, and two terminal connecting mechanisms 30 are symmetrically arranged about the socket 130. The conducting route portion 63 for electrically connecting a terminal connecting mechanism 30 and a fixed contact (not shown) provided in the socket 130 and brought into contact with an LED is disposed in each space 150 that has been made smaller than that of a substantially square-shaped accommodating portion. Accordingly, the size of the LED lamp lightning unit 201 as a whole is made smaller than that of an LED lamp lightning unit including the terminal connecting mechanism having the substantially square-shaped accommodating portion.

Furthermore, the number of terminal connecting mechanisms 30 provided in a switch may not be an even number and may be an odd number. Furthermore, the number of fixed contacts or movable contacts electrically connected to the terminal connecting mechanisms 30 may be freely changed in accordance with the design or the like of the switch.

The plate spring 40 may be configured such that, when the jig 90 is inserted from the second opening 55 into the jig insertion region 110 in the accommodating portion 51, the end of the jig 90 is brought into contact directly with the end 411 of the fixed portion 41 instead of being brought into contact indirectly therewith via the end 421 of the elastic portion 42.

The plate spring 40 does not necessarily have to be configured such that all of the fixed portion 41, the elastic portion 42, and the curved portion 43 are accommodated in the accommodating portion 51, and it is sufficient that at least the fixed portion 41 and the elastic portion 42 are accommodated in the accommodating portion 51.

When possible, an elastic member made of an insulating material may be used instead of the plate spring 40.

The jig support portion 70 does not necessarily have to be configured to warp when the jig 90 is inserted into the second opening 55, and may be rigid so as not to warp.

It will be appreciated that the constituent elements described in the foregoing embodiment may be combined as appropriate, and may be selected, replaced, or deleted as appropriate.

An embodiment of the present invention is directed to a terminal connecting mechanism including:
a plate spring having a fixed portion at one end thereof, an elastic portion at another end configured to be elastically deformable relative to the fixed portion, and a curved portion linking the fixed portion and the elastic portion;
an insulating housing having an accommodating portion including a jig insertion region that allows a jig to be inserted thereinto and an electric wire insertion region that allows a conductor portion of an electric wire to be inserted thereinto, configured to accommodate the fixed portion and the elastic portion of the plate spring, and further including an elastic deformation region in which the elastic portion is allowed to elastically deform passing through the electric wire insertion region toward the fixed portion, to the jig insertion region; and
a terminal electrode portion disposed in the accommodating portion, and configured to allow the conductor portion of the electric wire inserted into the electric wire insertion region to be in contact therewith,
wherein the accommodating portion includes:
   a first opening disposed on the electric wire insertion side of the accommodating portion, and configured to allow the conductor portion of the electric wire to be inserted into the electric wire insertion region in the accommodating portion;
   an electric wire insertion guide wall disposed from the first opening along an insertion direction of the electric wire so as to support the terminal electrode portion, and configured to guide the conductor portion of the electric wire inserted from the first opening, and to hold the conductor portion between the elastic portion of the plate spring and the terminal electrode portion;
   an inclined wall disposed so as to face the electric wire insertion guide wall and to be inclined toward the electric wire insertion guide wall along the insertion direction of the electric wire, wherein the fixed portion of the plate spring is fixed to the inclined wall; and
   a second opening disposed adjacent to the first opening, on the electric wire insertion side of the accommodating portion, and configured to allow the jig to be inserted into the accommodating portion to be brought into contact with the elastic portion of the plate spring, thereby canceling contact between the elastic portion and the conductor portion of the electric wire.

With this configuration, the accommodating portion includes an electric wire insertion guide wall disposed along an insertion direction of the electric wire and configured to guide the conductor portion of the electric wire, and an inclined wall disposed so as to face the electric wire insertion guide wall and to be inclined toward the electric wire insertion guide wall so as to reduce the space in the accommodating portion, instead of being parallel to the electric wire insertion guide wall, wherein the fixed portion of the plate spring is fixed to the inclined wall. Accordingly, the size of the housing is reduced, and thus the terminal connecting mechanism is smaller.

In one or more embodiments, the terminal connecting mechanism may be configured such that, when the jig is inserted from the second opening into the jig insertion region, an end of the fixed portion of the plate spring and an end of the elastic portion of the plate spring are brought into contact with each other, so that elastic deformation of the elastic portion is restricted.

With this configuration, the end of the fixed portion of the plate spring and the end of the elastic portion are brought into contact with each other, so that the elastic portion is restricted from elastically deforming, and the elastic portion 42 is prevented from plastically deforming. Accordingly, a restricting portion that restricts elastic deformation of the elastic portion 42 does not have to be additionally provided, and space conservation in the accommodating portion 51 is achieved. Furthermore, the end 411 of the fixed portion 41 of the plate spring 40 restricts elastic deformation of the elastic portion 42, and thus wear resistance is higher than that in the case where the restricting portion is made of a resin or the like.

In one or more embodiments, the terminal connecting mechanism may be configured such that the housing has a jig support portion that is disposed between the first opening and the second opening, and is closer to the second opening between the second opening and the end of the fixed portion, and
when the jig is inserted from the second opening into the jig insertion region, the jig is held between the jig support portion and two points that are an edge portion on the inclined wall side of the second opening and the end of the fixed portion.

With this configuration, when viewed in a cross-section along the insertion direction of the conductor portion of the electric wire and along the direction traversing the first opening and the second opening, the jig is held between the jig support portion and two points that are the edge portion on the inclined wall side of the second opening and the end of the fixed portion in contact therewith via the end of the elastic portion of the plate spring. Accordingly, the jig can be held in a hands-free state without supporting it with a hand or the like.

Furthermore, one or more embodiment may be directed to a switch including;
a fixed contact; and
the terminal connecting mechanism, in which the terminal electrode portion is electrically connected to the fixed contact.

With this configuration, the switch becomes smaller due to the terminal connecting mechanism being smaller.

In one or more embodiments, the switch may be configured to further include;
a movable contact configured to be in contact with and away from the fixed contact; and
a plunger configured to move back and forth between a returned position at which the movable contact is located away from the fixed contact and an operating position at which the movable contact is in contact with the fixed contact.

With this configuration, the switch becomes smaller due to the terminal connecting mechanism being smaller.

The terminal connecting mechanism in this disclosure is applicable to, for example, emergency stop push button switches and the like.

1. A terminal connecting mechanism comprising:
a plate spring having a fixed portion at one end thereof, an elastic portion at another end configured to be elastically deformable relative to the fixed portion, and a curved portion linking the fixed portion and the elastic portion;
an insulating housing having an accommodating portion including a jig insertion region that allows a jig to be inserted thereinto and an electric wire insertion region that allows a conductor portion of an electric wire to be inserted thereinto, configured to accommodate the fixed portion and the elastic portion of the plate spring, and further including an elastic deformation region in which the elastic portion is allowed to elastically deform passing through the electric wire insertion region toward the fixed portion, to the jig insertion region; and
a terminal electrode portion disposed in the accommodating portion, and configured to allow the conductor portion of the electric wire inserted into the electric wire insertion region to be in contact therewith,
wherein the accommodating portion includes:
a first opening disposed on the electric wire insertion side of the accommodating portion, and configured to allow the conductor portion of the electric wire to be inserted into the electric wire insertion region in the accommodating portion;
an electric wire insertion guide wall disposed from the first opening along an insertion direction of the electric wire so as to support the terminal electrode portion, and configured to guide the conductor portion of the electric wire inserted from the first opening, and to hold the conductor portion between the elastic portion of the plate spring and the terminal electrode portion;
an inclined wall disposed so as to face the electric wire insertion guide wall and to be inclined toward the electric wire insertion guide wall along the insertion direction of the electric wire, wherein the fixed portion of the plate spring is fixed to the inclined wall; and
a second opening disposed adjacent to the first opening, on the electric wire insertion side of the accommodating portion, and configured to allow the jig to be inserted into the accommodating portion to be brought into contact with the elastic portion of the plate spring, thereby canceling contact between the elastic portion and the conductor portion of the electric wire.

2. The terminal connecting mechanism according to claim 1, wherein, when the jig is inserted from the second opening into the jig insertion region, an end of the fixed portion of the plate spring and an end of the elastic portion of the plate spring are brought into contact with each other, so that elastic deformation of the elastic portion is restricted.

3. The terminal connecting mechanism according to claim 2,
wherein the housing has a jig support portion that is disposed between the first opening and the second opening, and is closer to the second opening between the second opening and the end of the fixed portion, and
when the jig is inserted from the second opening into the jig insertion region, the jig is held between the jig support portion and two points that are an edge portion on the inclined wall side of the second opening and the end of the fixed portion.

4. A switch comprising:
a fixed contact; and
the terminal connecting mechanism according to claim 1, in which the terminal electrode portion is electrically connected to the fixed contact.

5. The switch according to claim 4, further comprising:
a movable contact configured to be in contact with and away from the fixed contact; and
a plunger configured to move back and forth between a returned position at which the movable contact is located away from the fixed contact and an operating position at which the movable contact is in contact with the fixed contact.
